(19) United States
(12) Patent Application Publication
(10) Pub. No.: US 2018/0059623 A1
(43) Pub. Date: Mar. 1, 2018

(54) METHOD FOR PRODUCING A WATCH GLASS HAVING AT LEAST ONE GEMSTONE

(71) Applicant: Levitation AG, Zug (CH)

(72) Inventor: Michael Bonke, Oberwil bei Zug (CH)

(21) Appl. No.: 15/558,028

(22) PCT Filed: Jun. 30, 2015
(86) PCT No.: PCT/EP2015/064841

§ 371 Date: Sep. 13, 2017

(30) Foreign Application Priority Data
Mar. 13, 2015 (DE) 102015204619.2

(51) Int. Cl. G04B 47/04; G04B 39/02

(52) U.S. Cl. CPC G04B 47/042; G04B 39/02

(57) ABSTRACT

The invention relates to a method for producing a watch glass having at least one gemstone, comprising the steps of providing a support glass, providing a cover glass, introducing at least one recess into the support glass, providing at least one gemstone, inserting the at least one gemstone into the at least one recess in the support glass, placing the cover glass onto the support glass and securing the entire arrangement consisting of the support glass and the cover glass by means of a holding element surrounding a circumference of the entire arrangement. Furthermore, the invention relates to a watch glass which is produced by the method according to the invention.

### FIELD OF THE INVENTION

The invention relates to a method for producing a watch glass having at least one gemstone. The present invention also relates to a watch glass of said type, and to a watch which is equipped with a watch glass of said type.

### BACKGROUND OF THE INVENTION

Methods for producing watch glasses with gemstones or jewels inserted into recesses are well known. For example, in a method of said type from EP 1 347 349 A2, two glasses are heated and are thus melted together. This method however has the disadvantage that the shape of the recesses can change as a result of the heating of the glasses. As a result, the stones in the recesses are tilted or displaced. This has the result that the stones lose their clear and distinct alignment and position, which impairs the optical effect of the watch glass. Also, even only a slight tilting or displacement of one or stones can destroy the attractive, simple and homogeneous appearance of a watch glass with multiple gemstones.

### SUMMARY OF THE INVENTION

It is an object of the invention to propose a method for producing a watch glass having at least one gemstone, by means of which method a firm connection between two glasses is made possible without damaging the optical effect of the stones and of the watch glass.

Said object is achieved by a method for producing a watch glass having at least one gemstone, comprising the steps of providing a carrier glass, providing a cover glass, forming at least one recess into the carrier glass, providing at least one gemstone, inserting the at least one gemstone into the at least one recess of the carrier glass, placing the cover glass onto the carrier glass, and fixing the entire arrangement composed of the carrier glass and the cover glass via a holding element which surrounds a circumference of the entire arrangement. In this way, the recess can maintain its original shape. Thus, the orientation of the gemstone in its recess remains unchanged, which gives rise to a high-quality aesthetic appearance, in particular a uniform and harmonious appearance of a watch glass with a multiplicity of gemstones. Furthermore, the watch glass composed of the carrier glass and the cover glass is produced in an inexpensive and simple manner.

Here, the expression “carrier glass” refers to the glass which bears the gemstones, regardless of the arrangement of the glass in the watch glass. Accordingly, for example in the case of a watch glass with an upper and a lower glass, which has gemstones which are arranged in the upper glass, the upper glass is to be understood to be the carrier glass and the lower glass is to be understood to be the cover glass.

According to the invention, the cover glass may preferably have at least one recess.

In the context of the invention, the cover glass may have at least one recess which is aligned with the at least one recess of the carrier glass. It is thus possible for a first part of the gemstone to be arranged in the recess of the carrier glass and for a second part of the gemstone to be arranged in the corresponding recess of the cover glass. In this way, it is possible for each of the two glasses to be of thin form, which is advantageous for the optical effect of the watch glass, in particular if a large gemstone is used. Here, the sum of the thickness of the carrier glass and the thickness of the cover glass at the location of the recess may preferably be greater than the height of the gemstone.

According to the invention, it is furthermore possible for in each case at least one recess to be formed into the carrier glass and into the cover glass, into which recesses in each case one gemstone is inserted. In this context, both glasses carry at least one gemstone. Thus, the cover glass can also be considered as a carrier glass.

The holding element may preferably be formed as a sleeve. However, the holding element may be of any desired shape. In this context, it is advantageous if the holding element and the entire arrangement have the same shape at their contact surface.

According to the invention, it is preferably the case that a cohesive connection is produced between the holding element and the circumference of the entire arrangement composed of the carrier glass and the cover glass. Since the carrier glass and the cover glass are fixed to one another at the circumference by means of the holding element, the optical effect of the gemstone is not impaired.

The cohesive connection preferably extends over an entire contact surface between the holding element and the circumference of the entire arrangement. Thus, a relatively stable fixing of the two glasses is achieved because the two glasses are held together not only indirectly by means of the holding element but also directly by the cohesive connection formed over the entire contact surface.

The cohesive connection is particularly preferably formed as an adhesive connection. Thus, the watch glass is produced in a simple and inexpensive manner. To provide the adhesive connection, use may be made of a liquid adhesive that cure is or of an adhesive foil. The optical impression of the watch glass is not influenced by the adhesive connection, even if the adhesive that is used is changed as a result of the action of ultraviolet radiation over relatively long time periods, because the adhesive connection is produced at the circumference of the entire arrangement composed of the two glasses.

In an advantageous refinement of the present invention, a positively locking connection between the carrier glass and the cover glass is produced by means of the holding element. Thus, the carrier glass and the cover glass are held together by the action of a mechanical force. In this way, the glasses cannot detach from one another in the assembled state. For the fixing of the glasses to one another, it is possible in the context of the present invention for positively locking connections to be combined with cohesive connections.

The positively locking connection is advantageously formed as a screw connection. In this way, the positive locking connection can be of detachable form. This may be particularly advantageous if the two glasses have to be separated from one another, for example for the purposes of inspecting the gemstones. Other cohesive connections are likewise conceivable.

It is thus for example possible, in an advantageous manner, for the holding element to be shrink-fitted onto the entire arrangement composed of the carrier glass and the watch glass. This may be performed for example by heating the holding element in a first step, before the entire arrangement composed of the carrier glass and the watch glass is placed into the holding element, and subsequently cooling the holding element in a second step.

It may furthermore be advantageous for a multi-part holding element to be used. This permits greater flexibility in the assembly process, in particular if there is not a large amount of space available for the assembly process.

In order to dispense with additional components, at least a part of a watch housing may be used as the holding element. It is thus possible for potential assembly errors, the number of which generally increases with the number of components involved in an assembly process, to be reduced.

According to the invention, the recess may be formed in by means of a laser. The recess is thus formed in an exact and precise manner, which has the effect that the cover glass and the carrier glass bear closely against one another in an effective manner. The use of a laser is the most practical method, though the recess may also be formed by means of a water jet, ultrasound or diamond drill.

The recess is particularly preferably of hemispherical or spherical form, wherein the recess is in particular polished from the inside. This gives rise to a high-quality optical effect. However, the recess may also be of stepped or conical form.

A further aspect of the invention relates to a watch glass which is produced in accordance with the method according to the invention. Said watch glass is associated with the advantages mentioned above with regard to the method according to the invention. The watch glass can be produced in a stable and inexpensive manner. The invention also relates to a watch which has a watch glass according to the invention.

Further details, advantages and features of the present invention will emerge from the following description of exemplary embodiments on the basis of the drawing, in which identical or functionally identical parts are denoted in each case by the same reference designations, and in which:

### BRIEF DESCRIPTION OF THE DRAWINGS

FIG. 1 shows a plan view of a watch, which comprises a watch glass with diamonds,

FIG. 2 shows a highly simplified, schematic sectional view of a watch glass composed of a cover glass and a carrier glass according to a first exemplary embodiment of the present invention in the assembled state,

FIG. 3 shows a plan view of the watch glass according to the invention from FIG. 2 without diamonds, and

FIG. 4 shows a highly simplified, schematic sectional view of a watch glass composed of a cover glass and a carrier glass according to a second exemplary embodiment of the present invention in the assembled state.

### DETAILED DESCRIPTION

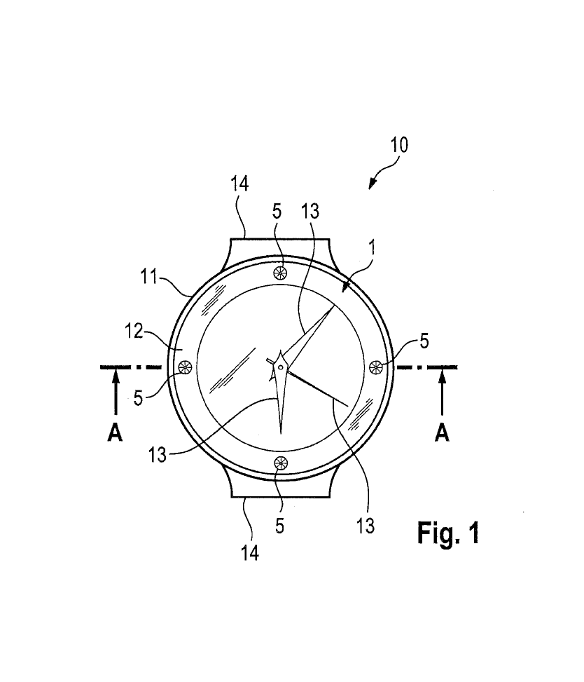

A watch glass 1 according to a first exemplary embodiment of the present invention will be described in detail below with reference to FIGS. 1 to 3.

FIG. 1 shows a watch 10 in the form of a wristwatch with a housing 11 and with a watch glass 1 according to the invention, which watch glass is arranged in the housing 11 and is equipped with gemstones 5. The housing 11 and the watch glass 1 are of circular form, though may have any other suitable shape, such as for example a rectangular, polygonal or other shape. For example, the watch glass 1 may also be of cushion-shaped or rectangular form. In particular, in this case, four gemstones 5, which are illustrated as diamonds, are arranged in the watch glass 1 with a constant radius and at uniform intervals with respect to one another in the circumferential direction. The position and the number of gemstones 5 may however be selected as desired in accordance with the watch design. For example, it is likewise possible to install one gemstone, two gemstones or 12 gemstones into the watch glass 1. The watch 10 furthermore has a clock face 12 which is formed for example from gold leaf, and three clock arms 13 for displaying the hours, minutes and seconds, and two connectors for a watch strap 14.

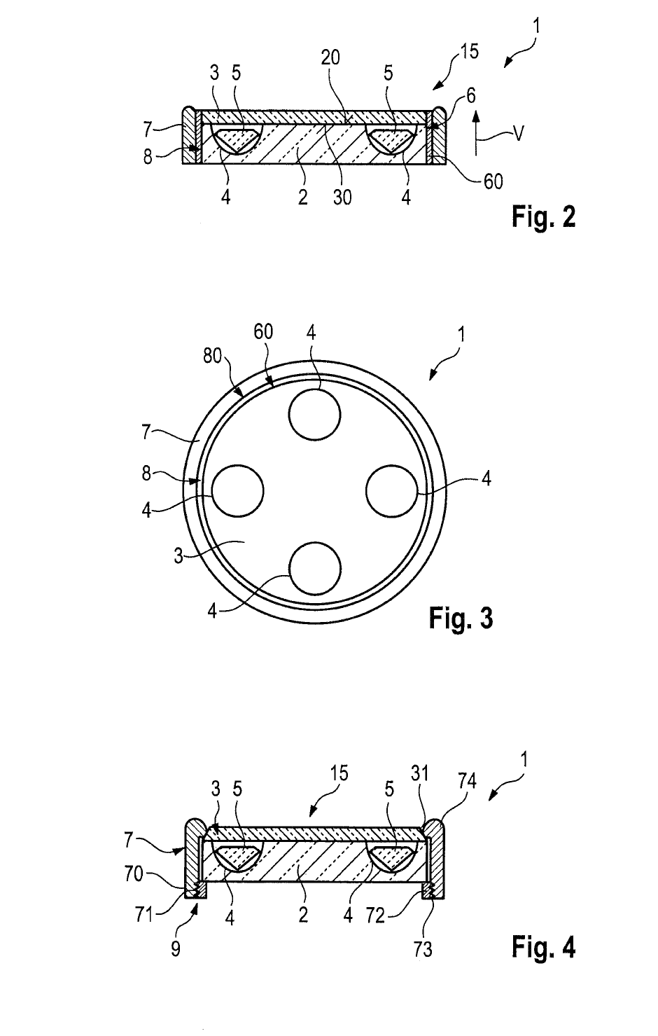

FIG. 2 is a highly simplified, schematic view of a section A-A of the watch glass 1 from FIG. 1 in the assembled state. The watch glass 1 has a carrier glass 2 and a cover glass 3. The carrier glass 2 and the cover glass 3 are formed from the same glass type, in particular mineral glass. Other glass types may also be used. It is possible in the context of the invention to combine different glass types.

In the carrier glass 2 there are arranged recesses 4 which serve for accommodating gemstones 5. The cover glass 3 and the carrier glass 2 are of circular form and have the same diameter. The glasses 2, 3 differ in terms of their thickness, wherein the cover glass 3 is of relatively thin form. It is however also possible for the two glasses 2, 3 to have the same thickness. Furthermore, an inner surface 20 of the carrier glass 2 and an inner surface 30 of the cover glass 3 are of planar form at the contact point of the two glasses 2, 3. In an alternative embodiment, it is however also possible for the inner surfaces 20, 30 to have identical and complementary curvatures.

In the fully manufactured watch glass 1, the glasses 2, 3 are held together by means of a holding element 7 which fully surrounds a circumference 6 of the entire arrangement composed of the carrier glass 2 and the cover glass 3. The holding element 7 is of sleeve-shaped form, wherein the internal shape thereof corresponds to the external shape of the glasses, such that stable fixing of the two glasses 2, 3 to one another is achieved.

To realize the watch glass 1 of FIGS. 2 and 3, the already provided glasses 2, 3 are placed onto one another after recesses 4 have been formed into the carrier glass 2 by means of a laser and gemstones have been inserted into the recesses 4. The recesses 4 may be formed not only by means of a laser, which is the most practical drilling method, but also mechanically by means of diamond drills, or by means of a water jet or ultrasound. Subsequently, the entire arrangement composed of the carrier glass 2 and the cover glass 3 is inserted into the holding element 7. Subsequently, the carrier glass 2 and the cover glass 3 are cohesively connected to the holding element 7. In particular, the holding element 7 is adhesively bonded to a circumferential surface 60 of the entire arrangement composed of the carrier glass 2 and the cover glass 3. For this purpose, a liquid adhesive is used, which cures after a certain amount of time. It is alternatively also possible for an adhesive foil to be used.

Furthermore, the holding element 7 and the entire arrangement composed of the carrier glass 2 and the cover glass 3 have substantially the same length in the vertical direction V. The vertical direction V runs perpendicular to the large surfaces of the glasses 2, 3. Here, the cohesive connection 8 between the holding element 7 and the entire arrangement of the glasses 2, 3 extends over an entire contact surface 80 of the holding element 7 and the entire circumferential surface 60. Alternatively, the holding element 7 may be partially connected to the circumferential surface 60. This can reduce the time and the costs for the fixing of the two glasses 2, 3 to one another.

In this exemplary embodiment, the holding element 7 is formed as part of the housing 11 of the watch 10. Thus, no additional component is required, whereby the assembly process is facilitated and potential assembly errors are reduced.

By means of the method according to the invention, the carrier glass 2 and the cover glass 3 are fixed to one another in a simple, inexpensive and fast manner and thus form a glass unit 15 in the assembled state. The two glasses 2, 3 bear closely against one another in air-tight fashion in the assembled state, such that they are no longer optically distinguishable to a viewer.

The watch glass 1 produced by means of the method according to the invention has an elegant appearance, because the glasses 2, 3 of the watch glass 1 are held together at their end by means of the holding element 7 and not by means of the contact surface between the inner sides 20, 30 of the two glasses 2, 3.

A watch glass 1 according to a second exemplary embodiment of the present invention will be described in detail below with reference to FIG. 4. FIG. 4 shows the watch glass 1 in the assembled state.

The watch glass 1 of the second exemplary embodiment basically differs from the first exemplary embodiment in that the carrier glass 2 and the cover glass 3 are engaged by the holding element 7 by means of a positively locking connection 9.

In particular, the positive locking connection 9 between the carrier glass 2 and the cover glass 3 is formed as a screw connection.

Here, a multi-part holding element 7 is used which has a first part and 70 in the form of a sleeve and a second part 72 in the form of a pedestal. The first part 70 is equipped with a first thread 71, and the second part 72 is equipped with a second thread 73. The first thread 71 is formed as an internal thread and the second thread 73 is formed as an external thread.

The second part 72 is connected to the carrier glass 2, in particular is adhesively bonded to the carrier glass 2. Such a connection between the second part 72 of the holding element 7 and the carrier glass 2 is however optimal.

The second part 72 is arranged on the lower side of the carrier glass 2, whereby the second part 72 is not optically visible at all, or is not easily optically visible. It is however alternatively possible for the second part 72 to be connected to the upper side of the cover glass 3.

Furthermore, in the case of the cover glass 3, on the outer surface, there is an inwardly chamfered bevel 31, wherein the first part 70 of the holding element 7 has a domed protuberance 74.

To fix the glasses 2, 3 to one another, the first part 70 is screwed onto the second part 72. Thus, in the assembled state of the watch glass 1, the glasses 2, 3 are firmly held together. The first part 70 of the holding element 7 presses the cover glass 2 against the carrier glass 3 by way of a contact point between the domed protuberance 74 and the bevel 31. Owing to the provision of the domed protuberance 74 and the bevel 31, an even neater optical effect of the watch glass 1 is made possible. Instead of a domed protuberance and a bevel, it is possible in an alternative refinement of the invention for the holding element 7 to be flanged over the entire circumference at both ends. To prevent the screw connection between the first part 70 and the second part 72 from loosening of its own accord, it is possible, depending on the application, for the first part 70 and the second part 72 to be adhesively bonded to one another.

In addition to the above written description of the invention, reference is hereby explicitly made, for the additional disclosure thereof, to the diagrammatic illustration of the invention in FIGS. 1 to 4.

Various features of the invention are set forth in the following claims.

1. A method for producing a watch glass having at least one gemstone, the method comprising:
providing a carrier glass;
providing a cover glass;
forming at least one recess into the carrier glass;
providing at least one gemstone;
inserting the at least one gemstone into the at least one recess of the carrier glass;
placing the cover glass onto the carrier glass; and
fixing an entire arrangement composed of the carrier glass and the cover glass via a holding element which surrounds a circumference of the entire arrangement.

2. The method of claim 1, wherein fixing the entire arrangement includes producing a cohesive connection between the holding element and the circumference of the entire arrangement.

3. The method of claim 2, wherein the cohesive connection extends over an entire contact surface between the holding element and the circumference of the entire arrangement.

4. The method of claim 2, further comprising forming the cohesive connection as an adhesive connection.

5. The method of claim 1, further comprising producing a positively locking connection between the carrier glass and the cover glass via the holding element.

6. The method of claim 5, wherein producing the positively locking connection includes producing the positively locking connection as a screw connection.

7. The method of claim 1, wherein the holding element is a multi-part holding element.

8. The method of claim 1, wherein the holding element includes at least a part of a watch housing.

9. (canceled)

10. The method of claim 1, wherein an inner surface of the carrier glass and an inner surface of the cover glass are of planar form at a contact point of the two glasses.

11. The method of claim 1, wherein an inner surface of the carrier glass and an inner surface of the cover glass have identical and complementary curvatures.

12. The method of claim 1, wherein the holding element is sleeve-shaped, and wherein the internal shape of the holding element corresponds to the external shape of the carrier glass and the cover glass.

13. The method of claim 1, wherein the contact surfaces of the cover glass and the carrier glass are held together solely via the holding element.

14. The method of claim 1, wherein the holding element includes a sleeve and a pedestal, wherein fixing the entire arrangement includes threadably engaging the sleeve with the pedestal.

15. The method of claim 14, further comprising positioning the cover glass and the carrier glass between the sleeve and the pedestal.

16. The method of claim 1, wherein the holding element presses the cover glass against the carrier glass via a contact point between a domed protuberance of the holding element and a bevel of the cover glass.

17. The method of claim 6, wherein the holding element is a multi-part holding element.

18. The method of claim 3, further comprising forming the cohesive connection as an adhesive connection.

19. The method of claim 2, wherein the holding element includes at least a part of a watch housing.

20. The method of claim 5, wherein the holding element includes at least a part of a watch housing.

21. The method of claim 7, wherein the holding element includes at least a part of the watch housing.
